(19) United States
(12) Patent Application Publication
(10) Pub. No.: US 2007/0026211 A1
(43) Pub. Date: Feb. 1, 2007

(54) Coextruded film capable of withstanding retort conditions

(76) Inventor: Bryn James Rabtor, Greenfield, MA (US)

Correspondence Address: MCANDREWS HELD & MALLOY, LTD, 500 WEST MADISON STREET, SUITE 3400, CHICAGO, IL, 60661, US

(21) Appl. No.: 11/191,782

(22) Filed: Jul. 28, 2005

(51) Int. Cl. B32B 27/34; B32B 27/30; B32B 27/32; B32B 27/08

(52) U.S. Cl. 428/212; 428/523; 428/500; 428/475.5; 428/522

(57) ABSTRACT

The present invention provides a multilayer film capable of withstanding retort conditions, and wherein each of the polymers making up the various layers of the film are capable of coextrusion with one another. In a preferred embodiment, the present film comprises a five-layer film, wherein a core layer and two outer layers are adhered to one another by two tie layers, and each of these layers are capable of coextrusion with one another.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates generally to the art of polymer films, and more specifically to a coextruded film designed to withstand retort conditions.

Multilayer films that are able to withstand retort conditions are increasingly important in the food packaging industry. Such films are used, among other things, to construct so-called retort pouches, in which food products can be sealed and cooked prior to delivery of the food product and package to a retailer for purchase by a consumer. Packaging food in retort pouches is preferable to packaging in traditional metal cans for a number of reasons, including the fact that food packaged in retort pouches does not take as long to cook as food in a conventional can, and food packaged in retort pouches tastes better than food provided in a conventional can.

In order to produce films for use in retort pouches and the like, laminators are generally employed. These devices laminate discrete layers of polymer together to arrive at a finished film that can withstand retort conditions. This lamination process requires multiple steps and can lead to inefficient use of machines and resources within a production facility.

Coextrusion is a more efficient method of making a multilayer film. With coextrusion, the output of two or more extruders is combined before the various melts exit the die. There are, however, difficulties associated with the development of a coextrusion process. When different polymer resins are used, they must have similar viscosities in order to flow together evenly. Too, the various polymer resins must have chemical compatibility to provide for bonding and recycling purposes. Finally, the various resins must have thermal compatibility to provide for the overall stability of the end product. These problems have arisen in the art with respect to development of a coextrusion process for a film capable of withstanding retort conditions.

What is needed, therefore, is a multilayer film capable of withstanding retort conditions, wherein the various resins used in the film are capable of being coextruded for efficient production of end product.

### BRIEF SUMMARY OF THE INVENTION

The present invention provides a multilayer film capable of withstanding retort conditions, and wherein each of the polymers making up the various layers of the film are capable of coextrusion with one another. In a preferred embodiment, the present film comprises a five-layer film, wherein a core layer and two outer layers are adhered to one another by two tie layers, and each of these layers are capable of coextrusion with one another.

In a preferred embodiment, the core layer of the present film includes a nylon polymer such as nylon 6. In alternative embodiments of the present film, the core layer includes other nylon polymers and/or ethylene vinyl alcohol copolymers, or combinations of thereof. It is preferred that the core layer comprise about 20 percent, by weight, of the total film.

The two outer layers of the present film preferably include a polyolefin polymer, and more preferably include polypropylene polymers such as polypropylene homopolymers, random copolymer polypropylene, or combinations thereof. It is preferred that each of the two outer layers comprise about 32 percent, by weight, of the total film.

The tie layers of the present film preferably include an ADMER® polymer. In alternative embodiments of the present invention, tie layers may include ethylene vinyl acetate copolymers, ethylene methyl acrylate copolymers, and combinations thereof. It is preferred that each of the two tie layers comprise about 8 percent, by weight, of the total film.

### BRIEF DESCRIPTION OF SEVERAL VIEWS OF THE DRAWINGS

FIG. 1 is an exploded view of a multilayer film produced in accordance with the teachings of the present invention wherein the various layers of the film are shown.

### DETAILED DESCRIPTION OF THE INVENTION

In a preferred embodiment, a multilayer film constructed in accordance with the teachings of the present invention includes a first outer layer, a first tie layer, a core layer, a second tie layer, and a second outer layer, with the core layer positioned between the two tie layers, and the first and second tie layers positioned between the first and second outer layers, respectively, and the core layer.

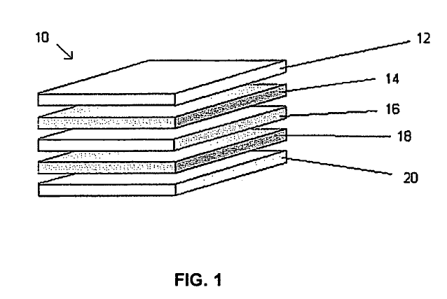

Turning now to the drawings, FIG. 1 provides an exploded view of a multilayer film of the present invention, 10, having a first outer layer 12, a first tie layer 14, a core layer 16, a second tie layer 18, and a second outer layer 20. Though the film illustrated in FIG. 1 is a five-layer film, it is contemplated that films having either more or less than five layers also fall within the scope of the present invention.

In a preferred embodiment of the present invention, the first and second outer layers of the film comprise a polyolefin polymer. Although any suitable polyolefin may be used, a preferred polyolefin polymer is polypropylene, which may comprise a polypropylene homopolymer, a random copolymer polypropylene, or a combination of the two. Various commercially available resins may be used for the tie layers. One preferred resin is ADMER®, grade QF551A, available from Mitsui Chemicals America, Inc. (Purchase, N.Y.). This tie layer resin adheres, by thermal reaction, to nylon, EVOH, polyolefin, other polymers, and metals such as aluminum, steel, and the like. Another preferred resin for the tie layers is Bynel®, grade 50E662, available from Du Pont, Inc. (Wilmington, Del.). Bynel is primarily composed of maleic anhydride modified polyolefin with some residual maleic anhydride, and may also contain small amounts of stabilizers, additives, and pigments.

It is further contemplated, however, that any of a variety of suitable tie layers may be used, including various tie layers comprised of modified maleic anhydride resins, ethylene vinyl acetate copolymers, ethylene methyl acrylate copolymers and combinations thereof.

It is also preferred that each of the two tie layers comprise about 8 percent, by weight, of the total film. However, it should be understood by those skilled in the art that the tie layers may comprise varying weights of the total film. In particular, the tie layers each may comprise from about 5 percent to about 15 percent, by weight, of the total film.

The core layer of the preferred five-layer film of the present invention, as described above, is preferably comprised of nylon or ethylene vinyl alcohol (EVOH) copolymer resin. A preferred nylon is nylon 6, which is readily available from a number of commercial sources, Nylon 6 is produced from a six-carbon monomer such as caprolactam or aminocaproic acid. Various nylon copolymers may also be used, such as nylon 6/6, which is produced from two six-carbon polymers such as hexamethylene diamine and adipic acid, or nylon 6/12, which is produced from a six-carbon lactam structure such as caprolactam, and a twelve-carbon lactam structure such as laurolactam, or other 6 and 12 carbon monomers. Nylon 5,10 is produced from a five-carbon monomer such as pentamethylene diamine, and a ten-carbon monomer such as sebacic acid. However, it should be understood by those skilled in the art that any suitable nylon polymer may be used in the core layer of the present invention, or an ethylene vinyl alcohol (EVOH) copolymer resin. A preferred EVOH copolymer resin is XEP-955, commercially available from Evalca (Houston, Tex.).

It is preferred that the core layer of the present invention comprise from about 10 percent to about 50 percent, by weight, of the total film. In a preferred embodiment, the core layer comprises a nylon 6 polymer and makes up about twenty percent, by weight, of the total film. The tie layers of the present film each preferably make up from about 5 percent to about 15 percent of the total film. More preferably, each tie layer preferably makes up about 8 percent, by weight, of the total film. Though in a preferred embodiment of the present invention, each tie layer is the same as the other in terms of composition and percent of the total film, it is contemplated that the two ties layers may be comprised of different compounds and may make up different percentages of the total film. The outer layers of the present film are preferably comprised of polypropylene, and preferably make up from about 30 percent to about 80 percent, by weight, of the total film. More preferably, each of the outer layers makes up about 32 percent, by weight, of the total film. Though in a preferred embodiment of the present invention, each outer layer is the same as the other in terms of composition and percent of the total film, it is contemplated that the two outer layers may be comprised of different compounds and may make up different percentages of the total film.

The multilayer film of the present invention is preferably produced by coextrusion techniques. Using this method, melted and plasticized streams of individual layer materials are fed into a coextrusion die. While in the die, the layers are juxtaposed and combined, after which they emerge from the die in a single multilayer film of polymeric material. Suitable coextrusion techniques are fully described in U.S. Pat. Nos. 5,139,878 and 4,677,017, incorporated herein by reference to the extent permitted by law. Coextrusion of the present film may be conducted at temperatures of from about 400° F. to about 510° F. Coextrusion techniques include the use of a feed block with a standard die, a multi-manifold die, such as a circular die, as well as a multi-manifold die such as used in forming flat cast films and cast sheets. The multilayer films of the present invention may also be made by blown film coextrusion. The film is formed using a blown film apparatus composed of a multi-manifold circular die head having concentric circular orifices. The multilayer film is formed by coextruding a molten layer through a circular die, and a molten layer on the other or each opposite side of the first layer through additional circular dies concentric with the first circular die. Next, a gas, typically air, is blown through a jet that is concentric with the circular dies, thereby forming a bubble that expands the individual layers. The bubble is collapsed onto itself to form a pair of multilayer films attached at two opposite edges. Usually, the pair of attached multilayer films are then cut apart at one or more of the edges and separated into a pair of multilayer films that can be rolled up. It is preferred that the films of the present invention are geared from a flat cast process. An example of the preferred process is provided below.

### EXAMPLE 1

### Method of Producing Films of the Present Invention

A preferred method for producing the films of the present invention is now described. As a first step, components are blended at a loss-in-weight blender and combined in the desired proportions (described more fully with respect to specific films, below), then sent to the feed portion of an extruder. This process allows for dry-blending of ingredients, thereby avoiding the need to utilize more expensive, fully compounded blends. Dedicated extruders mix, melt, and meter the components to a specific film layer. A feed block and flow plate channel five melt streams into a five, layer configuration The five melt streams are A) the first outer layer; B) the first tie layer; C) the core layer; D) the second tie layer; and E) the second outer layer. A flat, single slot die extrudes the film onto a smooth chill cast roll, producing the flat film product.

It will be appreciated by those skilled in the art that additives may be added to one or more layers of the film of the present invention in order to improve certain characteristics of the particular layer. Preferred additives include color concentrates, neutralizers, process aids, lubricants, stabilizers, hydrocarbon resins, antistatics, and antiblocking agents. A color concentrate may be added to yield a colored layer, an opaque layer, or a translucent layer. Suitable neutralizers include calcium carbonate and calcium stearate.

Lubricants that may be used in accordance with the present invention include higher aliphatic acid esters, higher aliphatic acid amides, metal soaps, polydimethylsiloxanes, and waxes. Conventional stabilizing compounds for polymers of ethylene, propylene, and other a-olefins are preferably employed in the present invention. In particular, alkali metal carbonates, alkaline earth metal carbonates, phenolic stabilizers, alkali metal stearates, and alkaline earth metal stearates are preferentially used as stabilizers for the composition of the present invention.

Hydrocarbon resins and, in particular, styrene resins, terpene resins, petroleum resins, and cyclopentadiene resins have been found to be suitable as additives in order to improve desirable physical properties of the film. These properties may include water vapor permeability, shrinkage, film rigidity, and optical properties. In particular, adhesive resins are preferred. A particularly preferred adhesive resin is sold under the trademark Bynel® by DuPont Corporation and is primarily composed of maleic anhydride modified polyolefin with some residual maleic anhydride and may also contain small amounts of stabilizers, additives and pigments.

Preferred antistatics include substantially straight-chain and saturated aliphatic, tertiary amines containing an aliphatic radical having 10-20 carbon atoms that are substituted by w-hydroxy-(C1-C4)-alkyl groups, and N,N-bis-(2-hydroxyethyl)alkylamines having 10-20 carbon atoms in the alkyl group. Other suitable antistatics include ethoxylated or propoxylated polydiorganosiloxanes such as polydialkysiloxanes and polyalkylphenylsiloxanes, and alkali metal alkanesulfonates.

Preferred antiblocking agents include organic polymers such as polyamides, polycarbonates, and polyesters. Other preferred agents include calcium carbonate, aluminum silicate, magnesium silicate, calcium phosphate, silicon dioxide, and diatomaceous earth.

In the preferred embodiments of the film of the present invention described hereinabove, the film structure is a five-layer structure. The five-layer structure allows for a core protected by two outer layers, one positioned on either side of the core layer, with tie layers in between to form an adhesive bond between the core layer and the outer layers.

The present invention is further illustrated by the following examples, which are not to be construed in any way as imposing limitations upon the scope thereof. On the contrary, it is to be clearly understood that various other embodiments, modifications, and equivalents which, after reading the description herein, may suggest themselves to those skilled in the art, may be used without departing from the spirit of the present invention and/or the scope of the appended claims.

### Additional Examples of Film Structures in Accordance with the Present Invention

A five-layer film having a total thickness of about 3 mils was produced using the formula set forth in Table 1. Note that for the tie polymers, ADMER® QF551A may be used and for the nylon polymer, Nylon 6 may be used.

TABLE 1
Formulation A - 4 Layer Formulation

| | Percent (w) | |
|---|---|---|
| Layer | of Film | Polymer |
| 1 (outer layer) | 32% | Polypropylene |
| 2 (tie layer) | 8% | Tie Polymer |
| 3 (core layer) | 20% | Nylon Polymer |
| 4 (tie layer) | 8% | Tie Polymer |
| 5 (outer layer) | 32% | Polypropylene |

The specific products used in the manufacture of the Table 1 film are provided in Table 2, below. Note that for the polypropylene polymer, Dow Inspire D114.00 may be used, ADMER® QF551A for the tie polymers, and BASF/Honeywell B135QP Nylon 6 for the nylon polymer. Further, the testing methodologies utilized with respect to the Examples set forth herein are provided in Table 3, below. Moreover, the physical properties of the films of the presently described technology as described herein were determined utilizing the testing methodologies as provided for in Table 3. It will also be appreciated by those skilled in the art that the physical property values noted in Table 3 have a standard deviation which shall not depart from the spirit and scope of the present invention.

TABLE 2

| | Percent (w) | |
|---|---|---|
| Layer | of Film | Polymer |
| 1 (outer layer) | 32% | Polypropylene |
| 2 (tie layer) | 8% | Tie polymer |
| 3 (core layer) | 20% | Nylon polymer |
| 4 (tie layer) | 8% | Tie polymer |
| 5 (outer layer) | 32% | Polypropylene |

TABLE 3

| | | ASTM | | |
|---|---|---|---|---|
| Property | | Method | Units | Values |
| Gauge | | D-2103 | mils | 3.00 |
| Yield | | FPA | sq inches/pound | 9,768 |
| | | B-11 | | |
| Gloss 45° | | D-2457 | Percent | |
| | | | Percent | |
| Haze | | D-1003 | Percent | 70.4 |
| Light Transmittance | | D-1003 | Percent | |
| COF | | D-1894 | | .41 |
| Tensile, Ultimate | MD | D-882 | psi | 9,150 |
| | TD | | psi | 6,856 |
| Elongation Ultimate | MD | D-882 | Percent | 440 |
| | TD | | Percent | 432 |
| 1% Secant Modulus | MD | D-882 | psi | 160,770 |
| | TD | | psi | 144,630 |
| MVTR | | F-1249 | g/100 sq in/day @ | 0.24 |
| | | | 100 F./90% rh | |
| OTR | | D-3985 | cc/100 sq in/day @ | 3.74 |
| | | | 73 F./0% rh | |
| Dart Impact | | D-1709 | grms | 418 |
| Elmendorf Tear MD | | D 1922 | grams | 72 |
| Elmendorf Tear TD | | D 1922 | grams | 124 |

In addition, the films described in tables 1 and 2 above were produced by a blown film coextrusion process. Blown film coextrusion involves using a blown film apparatus usually composed of a multi-manifold circular die head having concentric circular orifices. The multilayer film is formed by coextruding a molten layer through a circular die, and a molten layer on the other or each opposite side of the first layer through additional circular dies concentric with the first circular die. Next, a gas, typically air, is blown through a jet that is concentric with the circular dies, thereby forming a bubble that expands the individual layers. The bubble is collapsed onto itself to form a pair of multilayer films attached at two opposite edges. Usually, but not always, the pair of attached multilayer films are then cut apart at one or more edges and separated into a pair of multilayer films that can be rolled up.

The foregoing description of the embodiments of the invention has been presented for purposes of illustration and description, and is not intended to be exhaustive or to limit the invention to the precise form disclosed. The description was selected to best explain the principles of the invention and practical application of these principles in order to enable others skilled in the art to best utilize the invention in various embodiments and with such modifications as are suited to the particular use contemplated. It is intended that the scope of the invention not be limited by the specification, but be defined by the claims as set forth below.

1. A multilayer film comprising:
(a) a first outer layer;
(b) a first tie layer;
(c) a core layer, (d) a second tie layer; and
(e) a second outer layer,
wherein each of said layers are capable of coextrusion with each of the other said layers, and further wherein said core layer is positioned between said first and second tie layers, said first tie layer is positioned between said first outer later and said core layer, and said second tie layer is positioned between said second outer layer and said core layer.

2. The multilayer film of claim 1, wherein the first outer layer comprises a polyolefin polymer.

3. The multilayer film of claim 2, wherein said polyolefin polymer is selected from the group consisting of polypropylene homopolymer, random copolymer polypropylene, polypropylene block copolymer, derivatives thereof, and combinations thereof.

4. The multilayer film of claim 1, wherein the core comprises a polymer selected from the group consisting of nylons, modified maleic anhydride copolymers, ethylene vinyl alcohol copolymers, derivatives thereof, and combinations thereof.

5. The multilayer film of claim 4, wherein the polymer comprising said core is a nylon selected from the group consisting of nylon 6, nylon 6/6, nylon 6/12, nylon 5/10, and combinations thereof.

6. The multilayer film of claim 4, wherein said first outer layer comprises a polyolefin polymer.

7. The multilayer film of claim 6, wherein said polyolefin polymer is selected from the group consisting of polypropylene homopolymer, random copolymer polypropylene, polypropylene block copolymer, derivatives thereof, and combinations thereof.

8. The multilayer film of claim 6, wherein said second outer layer comprises a polyolefin polymer.

9. The multilayer film of claim 8, wherein said polyolefin polymer is selected from the group consisting of polypropylene homopolymer, random copolymer polypropylene, polypropylene block copolymer, derivatives thereof, and combinations thereof.

10. The multilayer film of either of claims 1, wherein said first tie layer comprises a polymer selected from the group consisting of an ADMER® polymer, Bynel® polymer, modified maleic anhydride copolymers, ethylene vinyl acetate copolymers, ethylene methyl acrylate copolymers, derivatives thereof, and combinations thereof.

11. The multilayer film of claim 10, wherein said second tie layer comprises a polymer selected from the group consisting of an ADMER® polymer, Bynel® polymer, modified maleic anhydride copolymers, ethylene vinyl acetate copolymers, ethylene methyl acrylate copolymers, derivatives thereof, and combinations thereof.

12. A multilayer film comprising:
(a) a first outer layer comprising from about 15 percent to about 40 percent, by weight, of said film;
(b) a first tie layer comprising from about 5 percent to about 15 percent, by weight, of said film;
(c) a core layer comprising about 10 percent to about 50 percent, by weight, of said film;
(d) a second tie layer comprising from about 5 percent to about 15 percent, by weight, of said film, and
(e) a second outer layer comprising from about 15 percent to about 40 percent, by weight, of said film, and
wherein each of said layers are capable of coextrusion with each of the other said layers, and further wherein said core layer is positioned between said first and second tie layers, said first tie layer is positioned between said first outer later and said core layer, and said second tie layer is positioned between said second outer layer and said core layer.

13. The multilayer film of claim 12, wherein the first outer layer comprises a polyolefin polymer.

14. The multilayer film of claim 13, wherein said polyolefin polymer is selected from the group consisting of polypropylene homopolymer, random copolymer polypropylene, polypropylene block copolymer, derivatives thereof, and combinations thereof.

15. The multilayer film of claim 12, wherein the core comprises a polymer selected from the group consisting of nylons, ethylene vinyl alcohol copolymers, derivatives thereof, and combinations thereof.

16. The multilayer film of claim 15, wherein the polymer comprising said core is a nylon selected from the group consisting of nylon 6, nylon 6/6, nylon 6/12, nylon 5/10, and combinations thereof.

17. The multilayer film of claim 15, wherein said first outer layer comprises a polyolefin polymer.

18. The multilayer film of claim 17, wherein said polyolefin polymer is selected from the group consisting of polypropylene homopolymer, random copolymer polypropylene, polypropylene block copolymer, derivatives thereof, and combinations thereof.

19. The multilayer film of claim 17, wherein said second outer layer comprises a polyolefin polymer.

20. The multilayer film of claim 19, wherein said polyolefin polymer is selected from the group consisting of polypropylene homopolymer, random copolymer polypropylene, polypropylene block copolymer, derivatives thereof, and combinations thereof.

21. The multilayer film of either of claim 12, wherein said first tie layer comprises a polymer selected from the group consisting of an ADMER® polymer, Bynel® polymer, modified maleic anhydride copolymers, ethylene vinyl acetate copolymers, ethylene methyl acrylate copolymers, derivatives thereof, and combinations thereof.

22. The multilayer film of claim 21, wherein said second tie layer comprises a polymer selected from the group consisting of an ADMER® polymer, Bynel® polymer, modified maleic anhydride copolymers, ethylene vinyl acetate copolymers, ethylene methyl acrylate copolymers, derivatives thereof, and combinations thereof.

23. A multilayer film comprising:
(a) a first outer layer comprising a polyolefin polymer, and further comprising about 32 percent, by weight, of said film;
(b) a first tie layer comprising a tie polymer, and further comprising about 8 percent, by weight, of said film;
(c) a core layer comprising a nylon or an ethylene vinyl alcohol copolymer, and further comprising about 20 percent, by weight, of said film;
(d) a second tie layer comprising a tie polymer, and further comprising about 8 percent, by weight, of said film; and
(e) a second outer layer comprising a polyolefin polymer, and further comprising about 32 percent, by weight, of said film, wherein said core layer is positioned between said first and second tie layers, said first tie layer is positioned between said first outer later and said core layer, and said second tie layer is positioned between said second outer layer and said core layer.

24. A film capable of withstanding retort conditions comprising a plurality of polymer layers, each of said polymer layers being comprised of at least one polymer adapted to be capable of coextrusion with the at least one polymer of each of the other said polymer layers.
